(19) United States
(12) Patent Application Publication
(10) Pub. No.: US 2011/0223297 A1
(43) Pub. Date: Sep. 15, 2011

(54) Anti-Caking Agent for Flavored Products

(75) Inventors: Robert CORKERY, Stockholm (SE); Adam FEILER, Sollentuna (SE); Julie Anne GROVER, Plano, TX (US); Chris DIMELOW, Leicestershire (GB); Eapen GEORGE, Frisco, TX (US)

(73) Assignee: PEPSICO., INC., Purchase, NY (US)

(21) Appl. No.: 12/723,100

(22) Filed: Mar. 12, 2010

(51) Int. Cl. A23L 1/226

(52) U.S. Cl. 426/302; 426/650

(57) ABSTRACT

The present invention generally relates to the use of porous particles to control the release of a liquid, such as the release of a flavor in a food product. Liquid components, such as flavorants, are loaded into porous particles to form a composition. The pore diameter, pore tortuosity and loading parameters determine the characteristics of the composition and the release profile of the liquid.

### BACKGROUND OF THE INVENTION

1. Technical Field

The present invention generally relates to use of a uniformly porous anti-caking agent in flavor compositions and flavored food products.

2. Background

Flavor is a complex sensory impression of a food or other edible substance, and is perceived primarily by its taste and smell. The flavor of food products is a major concern for practitioners in the food and beverage industry. It can be manipulated by including natural or artificial flavorants, which affect the senses that detect flavors. Flavorants, including mixtures of flavorants, can be applied to a food product as a topical seasoning or as an inclusion in the food ingredients as the food is being prepared. Flavoring compositions include at least one of solid flavorants, liquid flavorants, and other ingredients, and are used to deliver flavor, taste, seasoning or aroma to a food product.

When a mixture of flavorants is applied to or included in a food product and the food product is consumed, the consumer is exposed to and perceives all of the flavorants present almost simultaneously. This limits the variety of flavor experiences and profiles that practitioners in the food and beverage industry are able to provide consumers. It would be an improvement in the art to be able to provide consumers with a wider variety of flavor experiences and profiles than are currently available on the market.

Additionally, solid (typically, powdered or particulate) flavorants and flavoring compositions are known to experience an effect known as “caking”. Caking occurs when multiple particles of solid flavorant or flavoring composition bind together through physical bridging or compaction. Caking can reduce the effectiveness of flavor perception because it can reduce the surface area of solid flavorant available to be dissolved in the mouth of the consumer. Caking also limits a practitioner's ability to mix solid and liquid flavorants in a single stream or flavoring composition because the liquid flavorant often causes unwanted caking of a solid, particulate flavorant or other solid particulates present in the flavoring composition. It would be an improvement in the art to provide a mixture of solid and liquid flavorants which does not cause unwanted caking

Flavorants applied to the surfaces of foods, or included in food ingredients during preparation, are also susceptible to degradation of various types. Oil-based flavorants, including citrus and other natural flavorants, in particular, can degrade rapidly when exposed to oxygen. As a consequence, many topically flavored foods have a limited shelf life due to degradation of the flavorants. It would be another improvement in the art to protect flavorants from degradation.

### SUMMARY OF THE INVENTION

The invention comprises a method and apparatus for flavoring a food product, a flavoring composition which resists caking, and a food composition flavored using the method or apparatus. Porous anti-caking particles are loaded with one or more liquid flavorants and applied to a food product. In one embodiment, the porous particles comprise a highly ordered, substantially uniformly porous structure of silica. The duration, intensity and sequence of flavor release can be controlled using pore size, pore tortuosity and/or loading parameters. In some aspects of the present invention, food products are provided with complex flavor profiles heretofore unavailable in the art. In another aspect of the present invention, flavorants and flavoring compositions are protected against caking and degradation during and after creation of the flavored food product.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of the highly ordered porous anti-caking agent of one embodiment of the present invention;

FIG. 2 is a graph of flavor intensity versus time for anti-caking agents having different pore sizes;

FIG. 3 is a graph of flavor loading time versus tortuosity factor for anti-caking agents.

### DETAILED DESCRIPTION

According to the present invention, food products are flavored with porous anti-caking particles that have been loaded with at least one liquid flavorant. The particles are manufactured, loaded with liquid flavorant, optionally mixed with solid flavorant particles to make a flavoring composition, and applied to or mixed with foods and/or beverages in ways that allow a practitioner of the present invention to highly customize the flavor profile of a food product.

### Porous Particles

In one embodiment of the present invention, the porous anti-caking particles comprise porous silicon dioxide, or silica, particles. In a preferred embodiment, the pore diameters or pore sizes of the porous particles are substantially uniform. In another embodiment, the particles comprise a first fraction of the pores having a substantially uniform first pore diameter. In yet another embodiment, the particles also comprise a second fraction of the pores having a substantially uniform second pore diameter.

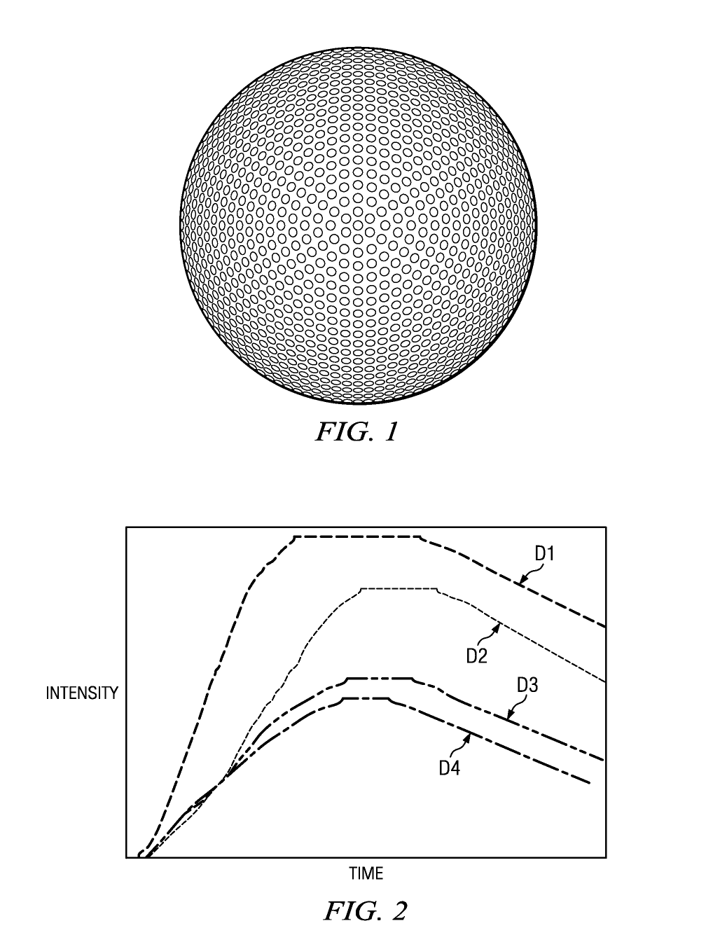

In one embodiment, the pores in the porous particles comprise a highly ordered hexaganol mesostructure of consistently sized pores having substantially uniform diameter. The high level order of the pore mesostructure is apparent when viewing mesoporous particles under transmission electron microscopy (TEM). FIG. 1 is a perspective representational depiction of a TEM image produced by a highly-ordered mesoporous silicon dioxide particle of the present invention.

In one embodiment, the porous silicon dioxide anti-caking particles can be formed by an acid catalyzed condensation reaction, which includes a templating agent. In this method, an acidic solution of tetraethyl orthosilicate (TEOS) and ethanol is mixed with a templating solution containing ethanol, water and a templating agent, such as an amphiphilic surfactant, and heated while stirring. One example of an amphiphilic surfactant that can be used with the present invention is a nonionic triblock copolymer composed of a central hydrophobic chain of polyoxypropylene flanked by two hydrophilic chains of polyoxyethylene. Suitable amphiphilic surfactants are sometimes referred to as poloxamers, and are available under the trade name Pluronics. The molecular structure of Pluronics in general is EOnPOmEOn, with EO representing ethylene oxide, PO representing propylene oxide, n representing the average number of EO units, and m representing the average number of PO units. For the Pluronic P104, n=27 and m=61 and MW=5900 g/mol. For Pluronic F127, MW=12600 g/mol, n=65.2, and m=200.4.

As the mixture is stirred and heated, the surfactant forms highly ordered micelles which, upon removal of the surfactant in the final step, ultimately leave behind the porous structure within the silicon dioxide matrix. After stirring and heating, the TEOS/surfactant mixture is aerosolized in an oven at high temperature (in one embodiment, over 250° C.) to produce a powder. Finally, the powder is calcined in an oven at very high temperature (in one embodiment, over 600° C.) until the polymer matrix is fully formed and the surfactant and any remaining solvent is burned away, leaving a flowing powder comprising discrete, approximately spherical silicon dioxide particles with a highly ordered internal porous structure.

The porous particles can then be separated according to outside diameter. In a preferred embodiment, the particles are separated based on differential settling velocities. In a preferred embodiment, the particles are substantially spherical, and the particles sizes range between 3 and 5 microns in diameter.

The porous particles described above are advantageous for use with the present invention because they have substantially uniform outer diameters (after separation) and at least one fraction of pores having substantially uniform pore diameters. In one embodiment, the pore diameters of at least one fraction of pores vary less than about 10%. In another embodiment, the pore diameters vary less than about 5%. The pore diameter is controlled by choosing an appropriate templating agent, which is preferably a surfactant. A particular surfactant will produce micelles with hydrophobic tails of specific diameter. The dimensions of the hydrophobic tails ultimately determine the dimensions of the pores in the silicon dioxide polymerization reaction described above. The arrangement of the micelles in solution also determines the regularity of the pore arrangement. The micelles are self-assembled with the hydrophobic tails pointing inwards away from the aqueous phase, and with loci of hydrophilic (polar) head groups in contact with the aqueous surrounds. The shape of the micelle/aqueous phase interface can be spherical, ellipsoidal, worm-like, or interconnected, like a 2D or 3D soft grid. When the preferred poloxamers are used with the present invention, the micelles are more worm-like, tubular or rod-like in shape, which pack into predominantly 2D arrays. However, in some of the particles in the present invention, there can exist some degree of interconnection between tubular pores to yield 3D connected structures, even for substantially unswollen samples. In the larger-pore particles, the micelles have been designed to swell to larger diameters via oil intercalation into the hydrophobic cores of the micelles. This often correlates with interconnections between rods, yielding 3D interconnected pore systems, for example, 3D hexagonal or cubic structures.

Of particular interest in the present invention are porous silica particles with highly ordered and substantially uniform pore sizes ranging between 1 nanometer and 12 nanometers, and preferably between about 3 nanometers and 10.5 nanometers. Mesoporous particles with a pore diameter of about 3 nanometers can be produced using cetyl trimethyl ammonium bromide (CTAB) as the templating agent. Mesoporous particles with a pore diameter of about 10.5 nanometers can be produced using a templating agent comprising Pluronic P104 with polypropylene glycol added to core of the micelle. In a preferred embodiment, about 0.18 grams polypropylene glycol (PPG) swelling agent added for every gram of P104 in the synthesis. Different templating agents can be used to produce particles with other substantially uniform pore sizes.

Additionally, particles with two or more fractions of pores having substantially uniform pore diameters can be produced. One way to create pores with bimodal pore size distribution is when pores become more spherical rather than elongate and tubular, and are interconnected by short, smaller diameter window-like pores. The pore systems in these cases can be described as interconnected cage pore systems, or ink-bottle pore systems. The template in this case can have a shape parameter when co-assembled with silica that leads to roughly spherical micelle shapes. The fusion of the micelles at the micellar aggregation and precipitation stage give rise to the nacent, relatively smaller window pores between roughly spherical, relatively larger pores. As in all the pores made by the templating procedures described herein, these nascent, template-filled windows become conduits between empty spherical pores upon subsequent removal of the template material.

Another way to make bimodal pores within one sample is to first synthesize a material using one template, and then subsequently mixing these particles into a new reaction mixture containing a second template, the first porous particles acting as a substrate on which the second material with differently size pores can be formed. As such, the internal pores will have a different diameter than the outer pores.

Another way to make bimodal pores is to introduce two different pore size reducing agents into a sample with monomodal pores. Such pore size reducing agents can be small particles, polymers, surfactants, lipids or other agents that are substantially difficult to remove once introduced. It may also be achieved by only introducing one pore size reducing agent into only a partial fraction of the pores.

The silica anti-caking particles of the present invention differ substantially from previous anti-caking amorphous silica particles. Other amorphous silica particles are generally made by dissolving silicon dioxide in sodium hydroxide solution then precipitating amorphous silica particles out of the solution by sulfuric acid addition. Amorphous silica particles prepared accordingly have a lower specific surface area, larger mean pore sizes, a much larger divergence in the range of pore sizes (well above 10% variance), and much wider variance in individual particle size than the silica particles used with the present invention. Such amorphous silica also forms irregular aggregates, whereas the spherical silica particles of the present invention resist aggregation and form a substantially free-flowing powder. A free flowing powder is a term known in the art with respect to particulate mixtures, and generally means a mixture of small particulates able to flow without substantially aggregating or clinging to one another. The uniformly sized, porous silica particles according to the present invention provide a number of surprising advantages over this amorphous silica, as described below.

### Anti-Caking Properties

In one embodiment of the present invention, the empty porous silica particles described above are loaded with at least one liquid flavorant and included in a flavoring composition. The principles outlined in this invention disclosure can be applied across a wide range of flavorants. Flavorants include extracts, essential oils, essences, distillates, resins, balsams, juices, botanical extracts, flavor, fragrance, and aroma ingredients including essential oil, oleoresin, essence or extractive, any product of roasting, heating or enzymolysis, and flavoring constituents derived from a spice, fruit or fruit juice, vegetable or vegetable juice, edible yeast, herb, bark, bud, root, leaf or similar plant material, meat, seafood, poultry, eggs, dairy products, or fermentation products thereof as well as any substance having a function of imparting or enhancing flavor, taste and/or aroma. Flavorants contemplated for use in the flavoring compositions of the present invention include any flavoring or taste-modifying agent that can be perceived by a consumer of food, including liquid flavorants (such as flavoring oils) and solid flavorants (such as particles of salt; sugar particles, including sucrose, dextrose, and fructose; polysaccharide particles, including maltodextrin and starches; and acidulant particles, including citric acid and malic acid). A liquid flavorant can also comprise or be used in conjunction with botanical extracts.

A liquid flavorant that can be used with the present invention must, whether by itself or in conjunction with a carrier fluid or solvent (which may or may not remain inside the pores of the particle), be described as wetting or partially wetting of the surface of the porous anti-caking particle. A liquid flavorant can be understood as “wetting” or “partially wetting” of a particular surface if, when a drop of the liquid flavorant is applied to a flat, horizontal surface made of the same material that makes up the porous particle, the drop has a contact angle of less than 90°. A liquid flavorant with a contact angle greater than 90° can be made wetting in a number of ways. For example, the liquid can be evaporated and then condensed on the interior rim of the pores. The pre-wetted rim will then facilitate further wetting by the otherwise non-wetting liquid. Non-wetting liquids can also be introduced in gaseous form and condensed back into a liquid while inside the particle pores. A liquid flavorant can also be loaded as a complex fluid such as a liquid crystal.

In one embodiment of the present invention, the porous anti-caking silica particles of the present invention are loaded with at least one liquid flavorant and then combined with a plurality of solid flavorant particles to form a complex flavoring composition that resists caking. In a preferred embodiment, the silica particles are loaded with at least one flavoring oil, and mixed with a plurality of salt or maltodextrin particles to form a flavoring composition for application to a food product. If the liquid flavorant were not loaded onto the silica particles of the present invention before being combined with the solid particulate flavorant, the liquid flavorant could contribute substantially to undesirable caking of the solid flavorant particles. Caking of a liquid flavorant and solid flavorant particle mixture makes it difficult to produce a predictable, uniform, reproducible flavoring composition for use in food products. The free-flowing and uniform particulate mixture of one embodiment of the present invention allows a practitioner to handle a complex flavoring composition, which was heretofore unavailable in the art, as a free-flowing powder instead of a liquid/solid composition mixture which may undesirably form cakes or clumps.

In another embodiment of the present invention, the porous anti-caking silica particles are loaded with at least one liquid flavorant and then included with a food product. In a preferred embodiment, a liquid flavorant is loaded onto the porous silica particles, and the loaded particles are included with other solid flavorant particles in an oatmeal mixture. Thus, the porous particles carry the liquid portion of the oatmeal flavoring composition as discrete particles instead of liquids, and therefore resist caking by the other solid constituents of the oatmeal flavoring composition. Upon hydration and consumption of the oatmeal mixture, the liquid flavorant is either dispersed in the aqueous medium or released into the mouth of the consumer when the oatmeal mixture is eaten. Other embodiments include dry food and flavorant mixtures, and powdered drink mixes.

### Flavor Loading and Perception

Applicants herein have determined that the anti-caking silica particles of the present invention can be used to deliver liquid flavorants in novel ways. Specifically, the pore size of the particles, the tortuosity of the pores, and the manner in which the particles are loaded with liquid flavorant largely determines how the liquid flavorants will be perceived by the consumer. In some cases, unloading parameters such as environmental temperature during release can also affect flavor perception.

With respect to pore size, Applicants conducted tasting studies to identify the effect pore size and other properties of the anti-caking silica particles play on flavor intensity perception over the time the product is in the mouth during consumption. As used herein, the term “flavor profile” when used to describe perception during consumption of a flavored food product includes the following characteristics: maximum flavor intensity, change in flavor intensity over time, rate of change in flavor intensity over time and total flavor intensity for at least one flavorant added to a food product.

The results of the studies showed a high level of repeatability. FIG. 2 depicts a graph showing the average perception of flavor profile for one study. Table 1 below identifies the properties of the test particles from the study flavor intensity graph of FIG. 2.

TABLE 1

| Particle Identifier | Pore Size | Templating Agent |
|---|---|---|
| D1 | 10.5 nm | P104 + PPG |
| D2 | 7.0 nm | F127 |
| D3 | 6.5 nm | P104 |
| D4 | 3.0 nm | CTAB |

All of the anti-caking particles in this study were loaded with chili oil (including capsaicin) and particles of each pore size D1 through D4 were topically applied to different samples of potato crisps. The chili oil mixture was added dropwise to a known mass of silica particles during continuous mechanical mixing of the same. The particle bed remained a dry powder until complete filling of the particle pores had been achieved. Immediately before saturation, the particles began caking or clumping together. Any excess liquid was consumed by mixing in additional porous particles until the powder became free-flowing again. The anti-caking particles can be described as substantially fully loaded when the pores are filled to approximately the maximum extent possible while still allowing the particles to remain a free-flowing powder.

Testers were asked to eat each sample of flavored potato crisps, chewing rhythmically, and rate the flavor intensity experienced over time. As can be seen in FIG. 2, Particle D1 (with the largest pores) exhibits a flavor profile with the highest slope towards maximum flavor intensity, the highest maximum flavor intensity, and the highest total flavor intensity (area under the curve). The remaining three particles can be seen as initially providing flavor profiles with an equivalent slope towards maximum intensity, until the slope of D2 increases more quickly towards a higher maximum flavor intensity. Particles D2 through D4 show that, as the pore size decreases, so does the maximum flavor intensity experienced and the total flavor intensity. Testing performed with particles of various pore sizes loaded with a citrus flavor showed similar results. The diameter of the pores exerts the most influence over flavorant release rate when the pores are relatively small enough to load, hold, and unload liquid flavorant by capillary action. If the pores are so large that interaction between the pore and the flavorant does not materially restrict the flow of liquid flavorant, pore diameter will not be an important factor. It has been determined that for pore sizes smaller than 500 nanometers, and in particular smaller than 100 nanometers, controlling the pore diameter will generally provide a practitioner of the present invention with some control over the flavor profile.

Another set of testing was performed with potato crisps flavored with anti-caking particles loaded with two different flavors. In these tests, a substantially uniform 6.5 nanometer pore size was chosen.

A first flavor composition was created by loading a sample of anti-caking particles with both chili oil and lime oil. The chili oil and lime oil were loaded into the particles as a mixed liquid system. The chili and lime oil mixture was added dropwise to a known mass of silica particles during continuous mechanical mixing of the same. The particle bed remained a dry powder until complete filling of the particle pores had been achieved. Immediately before saturation, the particles began caking or clumping together. Any excess liquid could be consumed by mixing in additional porous particles until the powder became free-flowing again. This set of mesoporous particles were substantially fully loaded when they sorbed approximately 0.72 grams of lime oil per gram of particles, and about 0.68 grams of chili oil per gram of particles.

A second flavor composition was created by fully loading a first sample of anti-caking silica particles with only lime oil, and fully loading a second sample of anti-caking silica particles with only chili oil.

Two samples of potato crisps were then topically flavored with each flavor composition, at a rate of 1% particles by weight of the potato crisps. When the potato crisps were consumed the two compositions surprisingly and unexpectedly resulted in different flavor profiles experienced by the tester.

For the first flavor composition, the chili flavor was perceived first, followed by the lime flavor. For the second flavor composition, the lime flavor was perceived first, followed by the chili flavor. These results were surprising and unexpected because one skilled in the art would expect the chili and lime flavors in the mixed liquid system of the first flavor composition to load into the particles randomly or simultaneously, and disperse in the mouth of the consumer randomly or simultaneously. Thus, the expected result would be for the first and second flavor compositions to exhibit similar flavor profiles. Surprisingly, this did not occur.

Without being limited by theory, Applicants herein believe the surprising result may be evidence of preferential wetting in capillary loading of the pores by the lime oil. The contact angle for a drop of lime oil on a flat silicon dioxide surface is about 10°, and the contact angle for chili oil is about 20°. The contact angle is related to the solid-liquid, solid-gas and liquid-gas interfacial energy densities. Also, the viscosity of lime oil is lower than the viscosity of chili oil. The viscosity of a particular flavorant is also an important factor in loading the porous particles. As used herein, a first flavorant is described as “more wetting” if it has a lower contact angle and/or a lower viscosity than a second flavorant. Similarly, a first flavorant is described as “less wetting” when it has a higher contact angle and/or a higher viscosity than a second flavorant. A first flavorant is described as “preferentially wetting” over a second flavorant if its contact angle and/or its viscosity allows it to load into or unload from the porous particles more quickly by capillary action than a second flavorant. A flavorant can be described as “non-wetting” if it substantially beads up on a flat, horizontal surface made of the same material as the porous particles. The degree of wetting for a liquid flavorant on a porous silica particle is closely related to its usefulness as an anti-caking agent. As such, only liquid flavorants which, when used either alone or with a carrier or solvent, or when applied as a condensate, exhibit wetting or partially wetting behavior are used with the silica particles of the present invention. Additionally, when more than one liquid flavorant is used with the present invention, liquid flavorants that are highly soluble with each other when combined together are generally treated as a single liquid flavorant for purposes of designing a flavor profile, unless the solubility of one or both flavorants has been altered.

These taste tests indicate that when the mixed liquid system is loaded into the porous particle pores, the lower contact angle/lower viscosity fluid (lime oil in this case) will load into the pores first, followed by the higher contact angle/higher viscosity fluid (chili oil in this case). It is theorized that the lime oil resides deeper inside the porous particles than the chili oil, which resides closer to the outer surface. When the loaded particles are placed in the mouth, the saliva in the mouth displaces the chili oil and the lime oil from the pores, but because the chili oil was loaded into the pores last (or is located closer to the exterior of the particle), it is the first to emerge and be perceived. The lime oil may also interact in other ways with the pore walls, such as by hydrogen bonding, to restrain its displacement more strenuously than chili oil.

Applicants' preferential wetting theory (or “last in, first out” theory) would also explain the flavor profile of the second flavor composition, wherein two different sets of particles each are fully loaded with only one flavorant. In the second flavor composition, according to the theory, the lime oil loads into the particles more quickly than chili oil due to preferential wetting. Therefore, it should also disperse into the mouth more quickly. Additionally, because the lime oil in this composition is not restricted by the action of the chili oil, the lime oil is immediately available to disperse into the mouth. The chili oil is perceived after the lime oil because it is less preferentially wetting than the lime oil, and therefore takes longer to be displaced by saliva. The lower viscosity of the lime oil may also allow it to disperse more quickly than the chili oil.

Testing has also been performed on the ability of the porous anti-caking silicon dioxide particles of the present invention to protect flavoring oils from oxidative and other environmental degradation. In the test, lime oil mixed with sunflower oil was sprayed on a control sample of potato crisps, while porous silica particles loaded with lime oil were applied to a test sample of potato crisps. Lime oil was chosen for its known instability. Both samples were subjected to periodic shelf life taste testing by testers. At 9 weeks, the control sample was described as “old” and “not fresh” by testers. By stark contrast, the test sample were described as “fresh” by testers until week 15. Therefore, the porous particles of the present invention can be used to protect flavorants from oxidative and other environmental degradation for significant periods of time.

The taste testing performed on the particles of the present invention also yielded some surprising results that are difficult to quantify. Taste testers have consistently noted that the lime oil and chili oil flavorants loaded onto these particles exhibit a more “rounded” and complex flavor than the flavorants themselves exhibit when applied directly to potato crisps without using the particles as a delivery medium. Again, without being limited by theory, it is hypothesized that when complex flavorants, such as lime oil or chili oil, are released from the narrow, uniform pores of the particles of the present invention, that minor variations between the individual components that make up the flavorant cause some components of the flavorant to be released slightly more quickly or more slowly than other components. For example, lime oil contains isomers of flavor and aroma compounds which differ only in three-dimensional structure and/or arrangement from one another. These isomers release at slightly different rates from the narrow, uniform pores, depending on how they interact with the material used to form the porous particles. The result, it is theorized, is that the taster perceives each component of the flavorant over an extended period of time, rather than all at once, resulting in a “rounder,” more complex flavor experience. This result was not expected prior to conducting the taste tests.

Applicants have also developed a theoretical model to relate the loading of a porous anti-caking particle with the tortuosity of the pore structure. Tortuosity is a measure of the complexity of the path a loaded flavor molecule would have to take to travel from the interior of the porous particle to the exterior. A more tortuous pore structure restricts the ability of a liquid flavorant to both load into and unload from the porous structure. The tortuosity of the pore system is controlled by choice of templating agent, synthesis and post-synthesis conditions.

The theoretical model is based on a modified Washburn equation, which itself is based on a wetting liquid being drawn into a straight, cylindrical pore which is open at both ends. The tortuosity factor, fₜₒᵣₜ, is included to account for variations in the tortuosity of the pores. The modified Washburn equation to calculate the time t_{L} for a liquid to penetrate a distance L into a horizontal, open ended capillary, where 11 is the liquid viscosity, Dₚₒᵣₑ is the pore diameter, γ_{LG} is the liquid-gas interfacial energy, and θ_{SLG} is the contact angle, is as follows:

t_{L}=8η(fₜₒᵣₜL)²/(Dₚₒᵣₑγ_{LG} cos θ_{SLG})

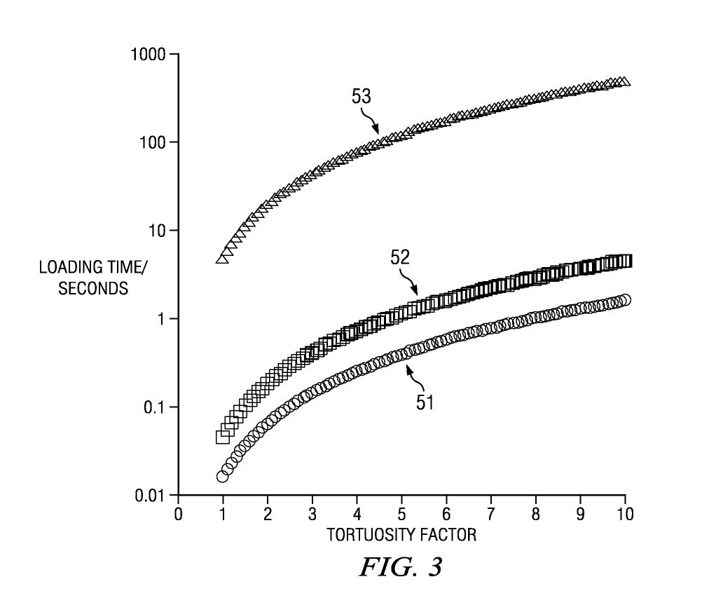

FIG. 3 depicts the theoretical loading time for three different liquids over a range of tortuosity factors. The line S1 represents water. The line S2 represents limonene. The line S3 represents a viscous edible oil, such as olive oil. FIG. 3 demonstrates that the tortuosity factor can radically affect the loading time. The tortuosity factor must be determined empirically for each templating agent, and will depend on the pore volume, density and diameter. Tortuosity can be defined as the geometric path length of the pore—this is preferably defined as a strict geometric/topological measure. Alternatively the tortuosity can be defined as a diffusion parameter, dependent on the size of the molecules moving through the pores. Either way, the tortuosity can be calculated as a statistical average, based on the size of the pores, how many pores are present and how interconnected they are. For highly interconnected pore systems, the effective geometric path length is shorter than for poorly interconnected pore systems.

Assuming the same factors that affect loading time affect the unloading time, the tortuosity also has an effect on how long it takes to disperse a loaded liquid flavorant into the consumer's mouth. Therefore, for every embodiment of the present invention involving changes to pore size, there is a corresponding embodiment that involves changes to pore tortuosity. Additionally, changing pore tortuosity allows a practitioner of the present invention to exercise still finer control over flavor profiles when used in conjunction with changes in pore size. Of course, liquid flavor unloading may be affected by other parameters as well, such as pressures, displacement energies, pore connectivity, etc.

The release rate of flavorant from the loaded particles of the present invention can also be influenced by providing one or more barriers on the exterior surface of the particles. Such barriers could include diffusion barriers, barriers that melt when placed into a warm environment, and barriers that dissolve in an aqueous or specific pH environment. Melt barriers can include, among other things, edible waxes or lipids. Diffusion and dissolution barriers can include gelled proteins, hydrocolloids, carbohydrates, starches, and polysaccharides, among others. The flavor profile of a flavoring composition can be influenced by providing sets of particles with barriers made of different materials, of different thicknesses, of different diffusion or dissolution rates, or a combination of these. Such coatings can be applied by known techniques, such as spraying, sprinkling or panning.

The release rate of flavorant from the loaded particles of the present invention can also be influenced by including an active transport agent within the pores of the particles. In one embodiment, the transport agent is a moisture swellable material inside the pores which expands to push a liquid flavorant out of the pore structure when introduced into an aqueous environment. In another embodiment, the transport agent modifies the viscosity or wetting properties of the liquid flavorant in order to increase or decrease its release rate. Examples of transport agents include: ethanol, edible oils, glycerin triacetate (triacetin), water, limonene, lipids, medium-chain triglycerides (MCTs), propylene glycol, glycerol (glycerin) and polysaccharides (starches, vegetable gums) which will act as viscosity modifiers and transport agents. Surfactants can be used as wetting agents and to complex (or form a gel) with volatile compounds to suppress their volatility.

In one embodiment, a single set of porous anti-caking particles with at least one fraction of pores having at least one substantially uniform pore diameter is loaded with a single liquid flavorant. The flavor profile of the liquid flavorant can be controlled by choosing a specific pore diameter or specific pore diameters. In a preferred embodiment, substantially all of the pores have a substantially uniform pore diameter. Thus, applying porous particles loaded with a single liquid flavorant and having a substantially uniform pore diameter chosen based on desired flavor profile allows a practitioner of the present invention to accurately control the flavor profile in accordance with specific consumer preferences. The uniform pore diameter also allows a practitioner to deliver a consistent product over many batches or over time in a continuous operation, and to deliver a rounder, more complex flavor experience. The uniform pore diameter and particle diameter also allows the practitioner of the present invention to closely control the anti-caking properties of the particles when they are included in a flavoring composition or in a food product, and evenly season a food product by spreading the liquid flavorant as a substantially free-flowing powder.

In another embodiment, the porous particles comprise a first fraction of pores having a first substantially uniform pore diameter, and a second fraction of pores having a second substantially uniform pore diameter which is different from the first pore diameter. In a preferred embodiment, the first fraction comprises at least about 40% of the pores of each particle, and the second fraction comprises at least about 40% of the pores of each particle. In another preferred embodiment, the first fraction comprises about 40% to about 60% of the pores of each particle, and the second fraction comprises about 40% to about 60% of the pores of each particle. This bimodal pore distribution allows a practitioner of the present invention to exercise still more control over flavor delivery and provide more complex flavor profiles. The flavorant will be released more quickly from the fraction having a larger pore diameter, and more slowly from the fraction having a smaller pore diameter.

In an embodiment employing one application of these principles, mixed liquid system particles (loaded with both a first liquid flavorant and a second liquid flavorant, wherein said second liquid flavorant is preferentially wetting over said first liquid flavorant) are combined with single-liquid system particles (loaded with only said second liquid flavorant). Extending the chili oil/lime oil examples above, a practitioner could flavor a potato crisp with the mixed chili oil and lime oil loaded particles, along with only lime oil loaded particles, wherein all of the particles have equal pore sizes. Such a composition would provide the consumer with a flavor profile wherein the chili and lime oil are perceived simultaneously, followed by an extended lime oil perception. In more general terms, this embodiment will provide a flavor profile wherein the first and second liquid flavorants are perceived substantially together initially, followed by an extended perception of the second liquid flavorant.

Alternatively, the single-liquid system particles could have pore diameters that are larger than the mixed liquid system particles. This would result in the second liquid flavorant being perceived first, followed by the first liquid flavorant, which in turn is followed by another second liquid flavorant perception.

In another embodiment, the single-liquid system particles could be loaded with a third liquid flavorant, which is different from the first and second liquid flavorants loaded into the mixed liquid loaded particles. This embodiment would exhibit a flavor profile comprising an initial perception of the first and third liquid flavorant substantially together, followed by the second liquid flavorant.

In one embodiment employing still another of these principles, the flavor profile of a single liquid flavorant is fine tuned by flavoring a food product with porous particles having different pore diameters, but loaded with a single liquid flavorant. The combination of different pore sizes would yield a composite time versus flavor intensity curve that would allow a practitioner of the present invention to customize the food product's flavor profile to very specific consumer preferences.

In yet another embodiment, a first liquid flavorant is loaded onto a particle of a first pore size and a second liquid flavorant is loaded onto a particle of a second pore size. Both particles are then applied to a food product. When the food product is consumed, the release rate and intensity of each liquid flavorant will be different. In one embodiment, the resulting flavor profile is a sequential flavor release. This can occur when a first liquid flavorant of equal or lesser preferential wetting to a second liquid flavorant is loaded onto a particle with a smaller pore size than particles loaded with said second liquid flavorant.

In another embodiment, the resulting flavor profile is a substantially simultaneous initial release of two liquid flavorants, but with a different flavor profile for each liquid flavorant than would occur with seasoning a food product with the liquid flavorants by themselves. In this embodiment, a first liquid flavorant of lesser preferential wetting than a second liquid flavorant is loaded into particles with a larger pore diameter than particles loaded with said second liquid flavorant.

Other embodiments are possible in accordance with the foregoing teachings for flavor compositions involving three or more liquid flavorants.

In another embodiment, a solid or liquid flavorant is loaded into the anti-caking particles using a solvent or carrier fluid that aids its sorption into the pores of the particles. In one embodiment, a less wetting (or even a non-wetting) flavorant is loaded into a porous particle by way of a more wetting solvent or carrier fluid. This allows a practitioner of the present invention to reverse the perception order of a first liquid flavorant and a second liquid flavorant in a mixed liquid system. In the case of the lime oil/chili oil system described above, the chili oil is dissolved or suspended in a solvent or carrier that is more wetting than lime oil, instead of being added alone. This results in the chili being sorbed by the pores before the lime oil, which in turn would cause the consumer to perceive the lime oil first, followed by the chili. In another embodiment, a solvent or carrier fluid is used to load a solid flavorant into the pores of the porous particles. In one embodiment, the solvent or carrier evaporates to leave the flavorant inside the pore structure.

The level of control over the caking properties and flavor perception of flavoring compositions available to a practitioner of the present invention is completely unknown in the art. None of these embodiments involve purposeful partial loading of porous particles with flavorants in order to influence the flavor profile, which would be materially wasteful, unnecessarily costly, and difficult to control. Partially loaded particles may be used to influence the anti-caking properties of the porous silica particles. In the present invention, fine adjustments to flavor perception using anti-caking silica particles can be made using substantially fully loaded particles based on preferential wetting and/or pore size and/or tortuosity, as described above in order to choose a desired flavor profile.

Additionally, the principles of the present invention depend heavily on the ability to produce porous particles with substantially uniform characteristics. Because the spherical and uniform nature of the particles has demonstrated a heightened ability to reduce caking in particulate flavorings, and because flavor loading and unloading has been found to be dependent on pore size, a randomly formed porous particle will not yield the level of control over flavor delivery and anti-caking properties of a flavoring composition available to a practitioner of the present invention. In the broadest application of the present invention, when only one type of anti-caking, porous particle loaded with only one flavor is used, extremely fine control over the flavor profile and product characteristics is possible through choice of pore diameter or tortuosity. Even this level of control is not available using a particle with randomly sized pores. The highly ordered nature of the pore structure in the particles of the present invention also enables practitioners to control the caking properties and flavor profile by controlling the tortuosity. Here again, particles with randomly sized pores or randomly tortuous structures will not deliver the level of control over the anti-caking and flavor delivery properties of a flavoring composition made possible by the present invention.

Food products contemplated for use in conjunction with the present invention include, but are not limited to, salty foods and/or savory foods including snack foods. Examples of such savory foods can include chips including, but not limited to, potato chips, tortilla chips, corn-chips, and nut-based chips. Other foods that can be used in accordance with various embodiments of the present invention include, but are not limited to, puffed snacks, popcorn, rice snacks, rice cakes, all types of crackers and cracker-like snacks, pretzels, breadsticks, meat and other protein-based snacks (e.g. jerky). Additionally foods including breakfast cereals, oatmeal, muesli, food bars including granola bars and confection bars, fruits and cookies can be used in accordance with various embodiments of the present invention. Other foods can also include produce and vegetables such as broccoli, cauliflower, and carrots, and nuts. Food products used with the present invention can also include powdered drink mixes and liquid beverages.

The flavoring compositions containing loaded anti-caking, porous particles can be topically applied to an outer surface of a food product, or included within a food product, and the term “applying” as used herein, includes both methods.

Although the present invention has been described with particular reference to the delivery of a desired flavor release profile by applying to a food substrate a plurality of particles with a first fraction of pores having a first substantially uniform pore diameter chosen based on a desired flavor release profile, and which have been loaded with a first liquid flavorant, the teachings herein can be applied more generally to porous particles loaded with other liquid components, and applied to other substrates. In one embodiment, a method comprises the step of loading a first set of porous particles with a first liquid component, wherein said particles have a first fraction of pores having a first substantially uniform pore diameter, and wherein said first pore diameter is chosen based on a desired release profile of said first liquid component. In another embodiment, the method comprises the additional step of applying said particles to a substrate. In another embodiment, a liquid release composition comprises a plurality of porous particles with a first fraction of pores having a first substantially uniform pore diameter and loaded with a first liquid component, a release profile for said first liquid component based on said first pore diameter. In another embodiment, the liquid release composition further comprises a substrate, wherein said particles are applied to a substrate. In other embodiments, liquid component is substituted for liquid flavorant, release is substituted for delivery or perception, and substrate is substituted for food product, in the embodiments described above and claimed with respect to food products and flavoring compositions and methods.

While the invention has been particularly shown and described with reference to a preferred embodiment and several examples, it will be understood by those skilled in the art that various changes in form and detail may be made therein without departing from the spirit and scope of the invention.

What is claimed is:

1. A method for flavoring a food product, said method comprising the steps of:
applying to said food product a flavoring composition comprising porous particles with a first fraction of pores having a first substantially uniform pore diameter and loaded with a first liquid flavorant, wherein said first pore diameter is chosen based on a desired flavor profile of said first liquid flavorant.

2. The method of claim 1 wherein said flavoring composition further comprises porous particles with a first fraction of pores having a second substantially uniform pore diameter, which is different from said first pore diameter, and loaded with at least one of said first liquid flavorant and a second liquid flavorant, to said food product, wherein said second pore diameter is chosen based on a desired flavor profile for said first and second liquid flavorants.

3. The method of claim 2 wherein said first liquid flavorant is preferentially wetting over said second liquid flavorant on said porous particles.

4. The method of claim 1 wherein said porous particles are loaded with a second liquid flavorant which is preferentially wetting over said first liquid flavorant on said porous particles.

5. The method of claim 4 wherein said flavoring composition further comprises porous particles having said first substantially uniform pore diameter and loaded with said second liquid flavorant only.

6. The method of claim 1 wherein said first liquid flavorant comprises a solvent or carrier fluid.

7. The method of claim 2 wherein said second liquid flavorant comprises a solvent or carrier fluid.

8. The method of claim 5 wherein said second liquid flavorant is preferentially wetting over said first liquid flavorant.

9. The method of claim 2 wherein said first pore diameter is larger than said second pore diameter, and wherein said first liquid flavorant is less preferentially wetting than said second liquid flavorant.

10. The method of claim 1 wherein said porous particles are loaded with a second liquid flavorant, wherein said first and second liquid flavorants are approximately equally wetting on said porous particles.

11. The method of claim 1 wherein said desired flavor profile is sequential release of said first liquid flavorant and said second liquid flavorant.

12. The method of claim 4 wherein said flavoring composition further comprises porous particles having said second substantially uniform pore diameter which is larger than said first pore diameter, and loaded with said second flavorant.

13. The method of claim 1 wherein said porous particles have a pore tortuosity, wherein said pore tortuosity is chosen based on a desired flavor profile.

14. The method of claim 1 wherein said flavoring composition further comprises a plurality of solid flavorant particles.

15. The method of claim 1 wherein said flavoring composition is a free-flowing powder.

16. The method of claim 14 wherein said solid flavorant particles comprise salt particles.

17. The method of claim 14 wherein said solid flavorant particles comprise at least one of, salt particles, sugar particles, polysaccharide particles, maltodextrin particles and acidulant particles.

18. The method of claim 1 wherein said porous particles are silicon dioxide particles.

19. The method of claim 1 wherein said first fraction comprises substantially all of the pores of each said particle.

20. The method of claim 1 wherein said first fraction comprises at least about 40% of the total number of pores of each said particle.

21. The method of claim 1 wherein said porous particles comprise a second fraction of pores having a second substantially uniform pore diameter which is different from said first pore diameter.

22. The method of claim 21 wherein said first fraction comprises at least about 40% of the total number of pores of each said particle and said second fraction comprises at least about 40% of the total number of pores of each said particle.

23. The method of claim 2 wherein said first fraction comprises substantially all of the pores of each said particle.

24. The method of claim 1 wherein said particles further comprise a barrier coating comprising at least one of a diffusion barrier coating, a melt barrier coating, and a dissolution barrier coating.

25. The method of claim 24 wherein said barrier coating comprises at least one of edible waxes, edible lipids, proteins, hydrocolloids, carbohydrates, starches, and polysaccharides.

26. The method of claim 1 wherein said particles further comprise a transport agent within said pores.

27. The method of claim 26 wherein said transport agent is at least one of surfactants, ethanol, edible oils, glycerin triacetate, water, limonene, lipids, medium-chain triglycerides, propylene glycol, glycerol and polysaccharides.

28. A food composition comprising:
a food product;
a flavoring composition comprising a plurality of porous particles with a first fraction of pores having a first substantially uniform pore diameter and loaded with a first liquid flavorant; and
a flavor profile based on said first pore diameter.

29. The food composition of claim 28 wherein said flavoring composition further comprises a plurality of porous particles with a first fraction of pores having a second substantially uniform pore diameter, and loaded with a second liquid flavorant; and wherein said flavor profile further comprises sequential or simultaneous perception of said first liquid flavorant and said second liquid flavorant.

30. The food composition of claim 28 wherein said plurality of porous particles are loaded with a second liquid flavorant, and wherein said flavor profile comprises sequential perception of said first liquid flavorant and said second liquid flavorant.

31. The food composition of claim 30 wherein said flavoring composition further comprises a plurality of porous particles having said first substantially uniform pore diameter and loaded with said second liquid flavorant, wherein said second liquid flavorant is preferentially wetting over said first liquid flavorant on said porous particles; and wherein said flavor profile comprises initial perception of said first liquid flavorant and said second liquid flavorant substantially simultaneously, followed by perception of said second liquid flavorant.

32. The food composition of claim 29 wherein said first pore diameter is larger than said second pore diameter, and wherein said first liquid flavorant is less preferentially wetting than said second liquid flavorant.

33. The food composition of claim 28 wherein said flavoring composition further comprises a plurality of porous particles having a second substantially uniform pore diameter which is larger than said first pore diameter, and loaded with said second liquid flavorant, wherein said second liquid flavorant is preferentially wetting over said first liquid flavorant on said porous particles; and wherein said flavor profile comprises initial perception of said second liquid flavorant, followed by said first liquid flavorant, followed by said second liquid flavorant.

34. The food composition of claim 28 wherein said flavor profile is further based on pore tortuosity.

35. The food composition of claim 28 wherein said flavoring composition further comprises a plurality of solid flavorant particles.

36. The food composition of claim 35 wherein said solid flavorant particles comprise salt particles.

37. The food composition of claim 35 wherein said solid flavorant particles comprise at least one of, salt particles, sugar particles, polysaccharide particles, maltodextrin particles and acidulant particles.

38. The food composition of claim 28 wherein said porous particles are porous silicon dioxide particles.

39. The food composition of claim 28 wherein said first fraction comprises substantially all of the pores of each said particle.

40. The food composition of claim 28 wherein said first fraction comprises at least about 40% of the total number of pores of each said particle.

41. The food composition of claim 28 wherein said porous particles comprise a second fraction of pores having a second substantially uniform pore diameter which is different from said first pore diameter.

42. The food composition of claim 41 wherein said first fraction comprises at least about 40% of the total number of pores of each said particle and said second fraction comprises at least about 40% of the total number of pores of each said particle.

43. The food composition of claim 29 wherein said first fraction comprises substantially all of the pores of each said particle.

44. The food composition of claim 28 wherein said particles further comprise a barrier coating comprising at least one of a diffusion barrier coating, a melt barrier coating, and a dissolution barrier coating.

45. The food composition of claim 44 wherein said barrier coating comprises at least one of edible waxes, edible lipids, proteins, hydrocolloids, carbohydrates, starches, and polysaccharides.

46. The food composition of claim 28 wherein said particles further comprise a transport agent within said pores.

47. The food composition of claim 46 wherein said transport agent is at least one of surfactants, ethanol, edible oils, glycerin triacetate, water, limonene, lipids, medium-chain triglycerides, propylene glycol, glycerol and polysaccharides.

48. A flavoring composition comprising:
a plurality of porous particles having a first substantially uniform pore diameter and loaded with a first liquid flavorant; and
a flavor profile based on said first pore diameter.

49. The flavoring composition of claim 48, further comprising:
a plurality of porous particles having a second substantially uniform pore diameter and loaded with a second liquid flavorant; and
wherein said flavor profile comprises sequential or simultaneous perception of said first liquid flavorant and said second liquid flavorant.

50. The flavoring composition of claim 48 wherein said plurality of porous particles are loaded with a second liquid flavorant, wherein said flavor profile comprises sequential perception of said first liquid flavorant and said second liquid flavorant.

51. The flavoring composition of claim 50 further comprising:
a plurality of porous particles having said first substantially uniform pore diameter and loaded with said second liquid flavorant, wherein said second liquid flavorant is preferentially wetting over said first liquid flavorant on said porous particles; and
wherein said flavor profile comprises initial perception of said first liquid flavorant and said second liquid flavorant substantially simultaneously, followed by perception of said second liquid flavorant.

52. The flavoring composition of claim 50 further comprising:
a plurality of porous particles having a second substantially uniform pore diameter which is larger than said first pore diameter, and loaded with said second liquid flavorant, wherein said second liquid flavorant is preferentially wetting over said first liquid flavorant on said porous particles; and
wherein said flavor profile comprises initial perception of said second liquid flavorant, followed by said first liquid flavorant, followed by said second liquid flavorant.

53. The flavoring composition of claim 49 wherein said first pore diameter is larger than said second pore diameter, and wherein said first liquid flavorant is less preferentially wetting than said second flavorant.

54. The flavoring composition of claim 48 wherein said flavor profile is further based on pore tortuosity.

55. The flavoring composition of claim 48 further comprising a plurality of solid flavorant particles.

56. The flavoring composition of claim 55 wherein said solid flavorant particles comprise salt particles.

57. The flavoring composition of claim 55 wherein said solid flavorant particles comprise at least one of, salt particles, sugar particles, polysaccharide particles, maltodextrin particles and acidulant particles.

58. The flavoring composition of claim 48 wherein said flavoring composition comprises a free flowing powder.

59. The flavoring composition of claim 48 wherein said porous particles comprise porous silicon dioxide particles.

60. The flavoring composition of claim 48 wherein said first fraction comprises substantially all of the pores of each said particle.

61. The flavoring composition of claim 48 wherein said first fraction comprises at least about 40% of the total number of pores of each said particle.

62. The flavoring composition of claim 48 wherein said porous particles comprise a second fraction of pores having a second substantially uniform pore diameter which is different from said first pore diameter.

63. The flavoring composition of claim 62 wherein said first fraction comprises at least about 40% of the total number of pores of each said particle and said second fraction comprises at least about 40% of the total number of pores of each said particle.

64. The flavoring composition of claim 49 wherein said first fraction comprises substantially all of the pores of each said particle.

65. The flavoring composition of claim 48 wherein said particles further comprise a barrier coating comprising at least one of a diffusion barrier coating, a melt barrier coating, and a dissolution barrier coating.

66. The flavoring composition of claim 65 wherein said barrier coating comprises at least one of edible waxes, edible lipids, proteins, hydrocolloids, carbohydrates, starches, and polysaccharides.

67. The flavoring composition of claim 48 wherein said particles further comprise a transport agent within said pores.

68. The flavoring composition of claim 67 wherein said transport agent is at least one of surfactants, ethanol, edible oils, glycerin triacetate, water, limonene, lipids, medium-chain triglycerides, propylene glycol, glycerol and polysaccharides.

69. A method comprising the step of loading a first set of porous particles with a first liquid component, wherein said particles have a first fraction of pores having a first substantially uniform pore diameter, and wherein said first pore diameter is chosen based on a desired release profile of said first liquid component.

70. The method of claim 69 further comprising loading a second set of porous particles with at least one of said first liquid component and a second liquid component, wherein said second set of porous particles have a first fraction of pores having a second substantially uniform pore diameter, which is different from said first pore diameter, wherein said second pore diameter is chosen based on a desired release profile for said first and second liquid components.

71. The method of claim 70 wherein said first liquid component is preferentially wetting over said second liquid component on said porous particles.

72. The method of claim 69 wherein said porous particles are loaded with a second liquid component which is preferentially wetting over said first liquid component on said porous particles.

73. The method of claim 72 further comprising loading a second set of porous particles with said second liquid component only, wherein said second set of porous particles have said first substantially uniform pore diameter.

74. The method of claim 73 wherein said second liquid component is preferentially wetting over said first liquid component.

75. The method of claim 70 wherein said first pore diameter is larger than said second pore diameter, and wherein said first liquid component is less preferentially wetting than said second liquid component.

76. The method of claim 69 further comprising loading said porous particles with a second liquid component, wherein said first and second liquid components are approximately equally wetting on said porous particles.

77. The method of claim 70 wherein said desired release profile is sequential release of said first liquid component and said second liquid component.

78. The method of claim 72 further comprising loading a second set of porous particles with said second liquid component, wherein said second set of porous particles have a second substantially uniform pore diameter which is larger than said first pore diameter.

79. The method of claim 69 wherein said porous particles have a pore tortuosity, wherein said pore tortuosity is chosen based on said desired release profile.

80. The method of claim 69 wherein said porous particles are silicon dioxide particles.

81. The method of claim 69 wherein said first fraction comprises substantially all of the pores of each said particle.

82. The method of claim 69 wherein said first fraction comprises at least about 40% of the total number of pores of each said particle.

83. The method of claim 69 wherein said porous particles comprise a second fraction of pores having a second substantially uniform pore diameter which is different from said first pore diameter.

84. The method of claim 83 wherein said first fraction comprises at least about 40% of the total number of pores of each said particle and said second fraction comprises at least about 40% of the total number of pores of each said particle.

85. The method of claim 69 further comprising applying said porous particles to a substrate.

86. A liquid release composition comprising a plurality of porous particles with a first fraction of pores having a first substantially uniform pore diameter and loaded with a first liquid component, and a release profile for said first liquid component based on said first pore diameter.

87. The composition of claim 86 wherein said composition further comprises a plurality of porous particles with a first fraction of pores having a second substantially uniform pore diameter, and loaded with a second liquid component; and wherein said release profile further comprises sequential or simultaneous release of said first liquid component and said second liquid component.

88. The composition of claim 86 wherein said plurality of porous particles are loaded with a second liquid component, and wherein said release profile comprises sequential release of said first liquid component and said second liquid component.

89. The composition of claim 87 wherein said composition further comprises a plurality of porous particles having said first substantially uniform pore diameter and loaded with said second liquid component, wherein said second liquid component is preferentially wetting over said first liquid component on said porous particles; and wherein said release profile comprises initial release of said first liquid component and said second liquid component substantially simultaneously, followed by release of said second liquid component.

90. The composition of claim 86 wherein said first pore diameter is larger than said second pore diameter, and wherein said first liquid component is less preferentially wetting than said second liquid component.

91. The composition of claim 86 wherein said composition further comprises a plurality of porous particles having a second substantially uniform pore diameter which is larger than said first pore diameter, and loaded with said second liquid component, wherein said second liquid component is preferentially wetting over said first liquid component on said porous particles; and wherein said release profile comprises initial release of said second liquid component, followed by said first liquid component, followed by said second liquid component.

92. The composition of claim 86 wherein said release profile is further based on pore tortuosity.

93. The composition of claim 86 wherein said porous particles are porous silicon dioxide particles.

94. The composition of claim 86 wherein said first fraction comprises substantially all of the pores of each said particle.

95. The composition of claim 86 wherein said first fraction comprises at least about 40% of the total number of pores of each said particle.

96. The composition of claim 86 wherein said porous particles comprise a second fraction of pores having a second substantially uniform pore diameter which is different from said first pore diameter.

97. The composition of claim 96 wherein said first fraction comprises at least about 40% of the total number of pores of each said particle and said second fraction comprises at least about 40% of the total number of pores of each said particle.

98. The composition of claim 86 further comprising a substrate, wherein said porous particles are applied to said substrate.
